(19) United States
(12) Patent Application Publication
(10) Pub. No.: US 2026/0055349 A1
(43) Pub. Date: Feb. 26, 2026

(54) LAUNDRY/CLEANING POWDER DETERGENTS IN WATER-SOLUBLE SACHETS

(71) Applicant: ZOBELE HOLDING S.p.A., Trento (IT)

(72) Inventors: Marco OLIVA, Trento (IT); Giampaolo FERRONATO, Trento (IT); Alessandro CAGNINA, Trento (IT); Victoria CHEPTENE, Trento (IT)

(21) Appl. No.: 19/140,910

(22) PCT Filed: Dec. 20, 2023
(86) PCT No.: PCT/IB2023/063025

§ 371 Date: Jun. 18, 2025

(30) Foreign Application Priority Data
Dec. 21, 2022 (IT) 102022000026367

(51) Int. Cl. C11D 17/04; C08J 5/12

(52) U.S. Cl. CPC C11D 17/045; C08J 5/121; C08J 2329/04

(57) ABSTRACT

Laundry/cleaning powder detergent in water-soluble sachets consisting of two water-soluble sheets mutually welded at their peripheral portion and containing said powder detergent inside. The formulation of said water-soluble sheets includes at least 30% by weight of active washing substances in water, in a mixture with PVOH and process adjuvants, said mixture being free of thermolabile, oxidizing, hazardous or sensitizing substances.

### FIELD OF THE INVENTION

The present invention concerns the field of laundry or home cleaning powder detergents, and particularly the sector of powder detergents packaged in single-dose sachets, which are water-soluble in the washing water.

### BACKGROUND OF THE PRIOR ART

Powder detergents are widely used for laundry washing and home and office cleaning and are currently available on the market in a wide variety of physical forms, such as loose powders, powders compressed into tablets, loose powders or tablets enclosed in a protective disposable film or in a water-soluble film, or powders directly formed into water-soluble sheets. In fact, powder detergents are still currently one of the preferred types of detergent on the market, for the reasons that they provide, the weight being equal, a greater number of washing doses compared to liquid detergents, they allow for use of paper packaging which can therefore be easily integrally recycled, and they offer an excellent washing efficiency. However, powder detergents also present some typical drawbacks that, over time, the above indicated various packaging forms tried to counter.

A first drawback of powder detergents is the tendency to agglomerate into lumps or blocks, following exposure to environmental humidity which is often present to a high degree in the usage environments. A second drawback is that powder detergents are easily dispersed in the usage environment, with consequent ease of direct contact with the user's skin/mucous membranes, especially during the loading operation, causing, for example, eye or respiratory tract irritation and skin allergies. Finally, a third drawback is the ease of overdosing with respect to the actual washing needs, resulting in an environmental pollution higher than that strictly necessary for the washing operations.

The above physical forms in which the powder detergents were offered on the market were therefore intended to remedy the abovementioned drawbacks, offering the consumer powder detergents in single unit doses, in a compressed or loose form, and protected by an adequate external covering or, alternatively, powder detergents directly formed into water-soluble sheets. All these packaging forms, in fact, solve the drawback of agglomeration, and also restrict or completely avoid any direct contact of a user with the powder detergent-depending on whether the covering is of the traditional type, and therefore to be unwrapped and disposed, or of the more recent water-soluble type— and, finally, they also indicate to the user a more correct quantitative use of the detergent, thanks to a unit dosage appropriate for the stated purpose.

Among the abovementioned packaging forms, the form that the present invention intends to develop is that of flat sachets consisting of a sandwich of two sheets of water-soluble material containing therein the detergent substances and the various additives necessary for an effective washing. The production plants of said sachets are in fact particularly simple and the sachets can furthermore be easily made in the most convenient sizes to allow for a particularly compact boxing. Furthermore, the abovementioned flat sachet form allows to include any possible heat-sensitive additives, irritating agents (e.g. percarbonate, TAED), or allergenic agents (e.g. enzymes) inside the sandwich.

A sandwich solution of the known art, wherein two water-soluble sheets are coupled and mutually welded by the activation of one or both surfaces with water/aqueous solution, still presents a significant drawback, because it allows to add only a small amount of active washing substances and process powder adjuvants inside the sandwich, since such amount is limited by the need to leave a significant part of the opposing surfaces of the two sheets free for contact with a sufficient amount of water to stably weld together the two sheets of the sandwich.

Other known types of sachet detergents use plastic sheets of similar films (e.g., polyvinyl alcohol-based films, paper-based films, starch-based films) to make the sandwich, thus introducing into the package components that do not show any washing effect and must therefore be considered as a packaging material. In this regard, it should be noted that the current regulations on packaging materials pressure to progressively reduce the use of packaging materials, especially in the European Union countries.

US-20210261885 discloses a particular method for manufacturing sheet detergents additionally containing active washing substances inside but does not disclose the use of such sheet detergents for manufacturing sachet detergents. Also, when it is necessary for these sheet detergents to contain any heat-sensitive additives, irritating agents, or allergenic agents, US-20210261885 suggests dispersing these additives within the sheet detergent base formulation, thus encountering all the drawbacks already discussed above, precisely in the light of which the solution of sachet detergents was initially selected as preferred for the present invention.

EP-1375377 discloses a sachet detergent, wherein the sachets are made up of two sheets of different nature, respectively a first water-soluble sheet and a second sheet made of a woven or non-woven material. However, both said sheets do not contain active washing substances and are therefore entirely waste materials in the washing water, whether they are of the water-soluble or water-insoluble type.

### TECHNICAL PROBLEM

The technical problem underlying the invention is therefore that of proposing a sachet detergent containing powder detergent, which is dissolvable in water and overcomes the above illustrated drawbacks of the powder detergent sachets currently available on the market.

Within the scope of this problem, a first object of the invention is to eliminate or to greatly reduce the extent of packaging materials which are inactive for the purposes of washing operations, in the sheets making up the powder detergent sachet. A second object of the invention is to be able to include, in a single sachet, a sufficient amount of powder detergent to carry out a wash in standard conditions, for example, approximately 60 g of powder detergent.

### SUMMARY OF THE INVENTION

This problem is solved, and these objects achieved, by means of a powder detergent sachet having the features defined in claim 1. The dependent claims define other preferred features of the powder detergent sachet of the invention.

Further features and advantages of the invention will anyhow become more evident from the following detailed description of a preferred embodiment of the same, given by mere way of non-limiting example.

### DETAILED DESCRIPTION OF THE PREFERRED EMBODIMENT

The present invention is directed to a laundry/cleaning powder detergent packaged in water-soluble sachets. Each detergent sachet is made up, in a per se known manner, of two sheets of water-soluble material mutually welded at their outer edges and contains a solid powder detergent inside.

The detergent contained inside the water-soluble sachet is a powder detergent specific for the sachet intended use, e.g., laundry washing or floor and other surfaces cleaning. Depending on the uses it is intended for, the powder detergent may contain other powder components, such as washing additives, oxidants, enzymes, antibacterial agents, perfuming agents and other similar components.

The two sheets of water-soluble material are preferably sealed with water, by wetting with water a thin peripheral strip of the sheets which are then brought into close contact and dried. Alternatively, said sheets can be sealed by heat application. The width of the peripheral strip of water- or heat-“welding”can range from 1 mm to 15 mm.

The water-soluble sachets of the invention preferably have a square or rectangular shape, for example with dimensions of 1000 mm×1000 mm, and a maximum thickness of 20 mm, but it is understood that said water-soluble sachets may also have other geometric shapes, such as circular, oval, polygonal etc., with sharp or rounded edges, depending on the needs of each individual application.

According to the main feature of the invention, the two water-soluble sheets which make up the sachet are mainly composed, unlike what happens in the known art, of active washing substances, where this term is intended to indicate components which are active in any washing or cleaning action. The washing action can indifferently be aimed at clothing and fabric items in general and be carried out in a washing machine, or it can be aimed at cleaning floors, walls and other surfaces and furnishing elements. In the case of clothing and fabric washing, it is generally sufficient, in a per se known manner, to add the water-soluble sachet to the washing machine load and to activate the selected type of wash, temperature and time; by dissolving, the water-soluble sachet will release firstly the active washing substances contained in the water-soluble sheets, and secondly the powder detergent plus other additives contained inside the sachet, leaving a minimum residue of packaging materials, passive to the washing or cleaning action, essentially consisting of a small percentage of water-soluble film-forming agent, such as PVOH. In the case of high washing machine load, where the fabrics take longer to get wet, this “double-release action” also allows to slow down the dissolution of the solid detergent until the entire washing machine load is soaked in water, thus avoiding a localized release, and favouring a homogeneous distribution of the cleansing action. In the case of floor and surface cleaning, the user just needs to put water and a detergent water-soluble sachet of the present invention into a container; after a short mixing, a ready-to-use water-based cleaning solution is obtained.

According to a feature of the present invention, the active washing substances incorporated into the water-soluble sheets can include any active washing substance or washing adjuvant, provided that they are not thermolabile and do not present an oxidizing, hazardous or sensitizing effect on human skin or mucous membranes. All the detergent components which are thermolabile or have oxidizing, hazardous or sensitizing effect on human skin or mucous membranes are in fact placed inside the sachet, in the form of powders, to avoid any contact of the same with the user's skin, eyes, mouth or other mucous membranes.

According to another feature of the invention, the water-soluble sheets consist of over 50% by weight, and preferably over 60% by weight, but in any case, not less than 30% by weight, of said active washing substances, the remainder consisting of process adjuvants, colourants, preservatives, antibacterials, bacteriostatic agents, plasticizers and a water-soluble film-forming agent, such as PVOH. Examples of process adjuvants are, but are not limited to, silica, glycerine, starch.

According to yet another feature of the invention, each water-soluble sachet contains a total amount of powder detergent to be released during the washing cycle which is in line with the detergent dose normally used in a standard washing cycle, for example, approximately 60 grams of powder detergent. Other embodiments can contain different amounts of powder detergent, calculated for washing with low or high hardness water or for washing in mild or severe dirty conditions.

According to a further feature of the invention, the powder detergent contained in the water-soluble sachets can be divided into several compartments of the sachet, separated by internal welding lines. Each compartment of the sachet preferably contains an identical fraction of powder detergent, so that the user can use a single portion of the sachet, separating it from the remaining portions along one of said internal welding lines, when it is required a washing or cleaning action with less quantitative effort compared to a standard washing/cleaning operation.

However, it is understood that the invention should not be considered as limited to the specific arrangement illustrated above, which is only an exemplary embodiment thereof, but that different variants are possible, all of which are within the reach of a person skilled in the art, without thereby departing from the scope of protection of the invention itself, as defined by the following claims.

1-6. (canceled)

7) Laundry/cleaning powder detergent in water-soluble sachets consisting of two water-soluble sheets mutually welded at their peripheral portion and containing said powder detergent inside, wherein the formulation of said water-soluble sheets comprises at least 30% by weight of active washing substances in water, in a mixture with PVOH and process adjuvants, such us silica, glycerin, starch, colorants, preservatives, antibacterials, bacteriostatic agents, plasticizers and others, said mixture being free of thermolabile, oxidizing, hazardous or sensitizing substances, all the detergent components which are thermolabile or have oxidizing, hazardous or sensitizing effect on human skin or mucous membranes being placed inside said water-soluble sachets, in the form of powders.

8) The laundry/cleaning powder detergent in water-soluble sachets as in claim 7, wherein the formulation of said water-soluble sheets comprises 50% by weight or more, and preferably 60% by weight or more, of said active washing substances.

9) The laundry/cleaning powder detergent in water-soluble sachets as in claim 7, wherein each water-soluble sachet contains a total amount of powder detergent to be released during the washing cycle in line with the detergent dose of 60 grams normally used in a standard washing cycle.

10) The laundry/cleaning powder detergent in water-soluble sachets as in claim 7, wherein each water-soluble sachet is divided into several compartments separated by internal welding lines.

11) The laundry/cleaning powder detergent in water-soluble sachets as in claim 10, wherein each of said water-soluble sachet compartments separated by internal welding lines contains an identical amount of powder detergent.

12) The laundry/cleaning powder detergent in water-soluble sachets as in claim 8, wherein each water-soluble sachet contains a total amount of powder detergent to be released during the washing cycle in line with the detergent dose of 60 grams normally used in a standard washing cycle.

13) The laundry/cleaning powder detergent in water-soluble sachets as in claim 8, wherein each water-soluble sachet is divided into several compartments separated by internal welding lines.

14) The laundry/cleaning powder detergent in water-soluble sachets as in claim 9, wherein each water-soluble sachet is divided into several compartments separated by internal welding lines.
